(19) United States
(12) Patent Application Publication
(10) Pub. No.: US 2010/0064366 A1
(43) Pub. Date: Mar. 11, 2010

(54) Request processing in a distributed environment

(75) Inventor: Jianfeng Zhang, Hangzhou (CN)

Correspondence Address: VAN PELT, YI & JAMES LLP, 10050 N. FOOTHILL BLVD #200, CUPERTINO, CA, 95014, US

(73) Assignee: Alibaba Group Holding Limited

(21) Appl. No.: 12/584,665

(22) Filed: Sep. 9, 2009

(30) Foreign Application Priority Data
Sep. 11, 2008 (CN) 200810211848.3

(51) Int. Cl. G06F 21/00

(52) U.S. Cl. 726/22

(57) ABSTRACT

A method for request processing in a distributed system includes obtaining event request information at a plurality of application servers, at least some of the event request information pertaining to a resource access request that is sent from a client terminal and that corresponds to a Uniform Resource Locator (URL) resource, transferring the event request information to an anti-attack server, determining, based at least in part on the at least some of the event request information, a total number of access requests to the URL resource made by the client terminal in a specified period of time, and determining, based at least on the total number of access request determined and a predefined access rule, whether an abnormal access request has been made by the client terminal.

### CROSS REFERENCE TO OTHER APPLICATIONS

This application claims priority to People's Republic of China Patent Application No. 200810211848.3 entitled METHOD AND SYSTEM FOR PROCESSING ABNORMAL REQUEST IN DISTRIBUTED APPLICATION filed Sep. 11, 2008 which is incorporated herein by reference for all purposes.

### FIELD OF THE INVENTION

The present invention relates to the field of Internet security and in particular, to a method and a system for processing an abnormal request in a distributed environment.

### BACKGROUND OF THE INVENTION

With rapid development of the Internet, large-scale portal web sites face growing security risks. One type of risk is a denial-of-service (DoS) attack, where there are a large number of concurrent requests such as requests initiated by multiple machines simultaneously. DoS attacks can severely slow down the servers or crash the web site entirely. Another type of risk comes from crawler programs that may come from various search engines, competitors machines, commercial data analysis web sites and so on. Web crawlers may initiate a large number of requests, thus negatively impacting the performance of the servers. It is easy for such repetitive and highly concurrent abnormal user requests to exhaust server resources and preventing the normal user requests from being processed.

### BRIEF DESCRIPTION OF THE DRAWINGS

Various embodiments of the invention are disclosed in the following detailed description and the accompanying drawings.

FIG. 1 is a block diagram illustrating an embodiment of a system that is configured to handle abnormal requests.

FIG. 2 is a flowchart illustrating an embodiment of a method for processing a request in a distributed application.

FIG. 3 is a flowchart illustrating an embodiment of a request processing process that utilizes a filter.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

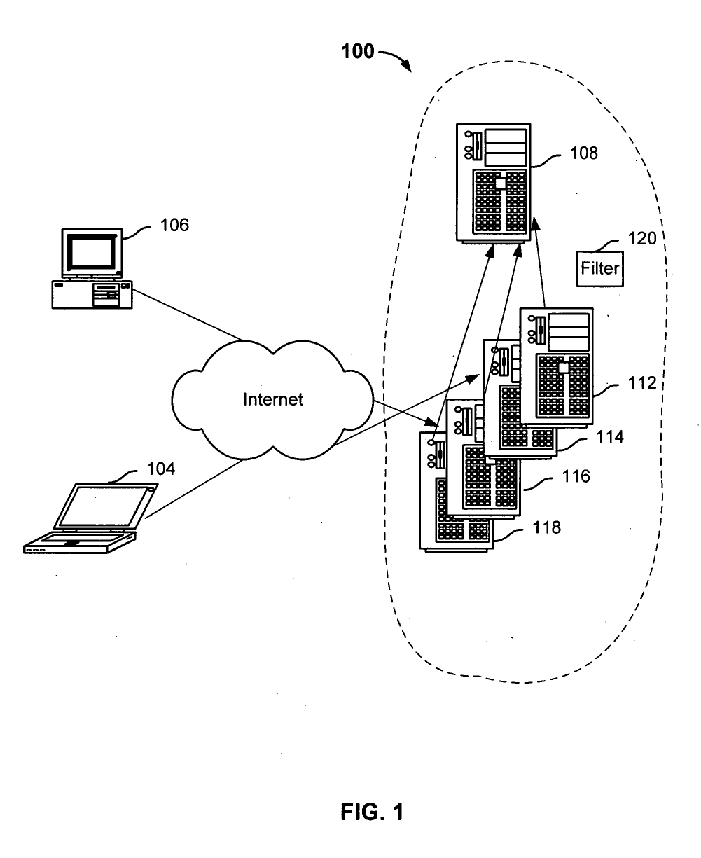

FIG. 1 is a block diagram illustrating an embodiment of a system that is configured to handle abnormal requests. In this example, system 100 includes a plurality of application servers 112, 114, 116, and 118. Although four application servers are used for purposes of example, different number of application servers may be used in other embodiments. URL resource access requests from clients such as 104 and 106 are received by the application servers and transferred to an anti-attack server 108 as appropriate. In some embodiments, the event request information includes: time information of when each of the access requests is received, one or more target URLs associated with the access requests, and identifier information of the client terminal associated with the access request.

The anti-attack server collects statistics of URL accesses from individual clients and makes determinations of whether certain access requests are abnormal. In some embodiments, the anti-attack server is adapted to count the number of accesses to the same URL resource made by a client terminal with the same identifier in unit time according to the event request information received from the application servers and identify an abnormal access request according to the counted result and a predefined access rule corresponding to the URL resource.

In some embodiments, the system optionally includes a filter 120 adapted to read an identifier information blacklist of each of the application servers and send the event request information to the anti-attack server 204 if the identifier information of the client terminal does not lie in the blacklist.

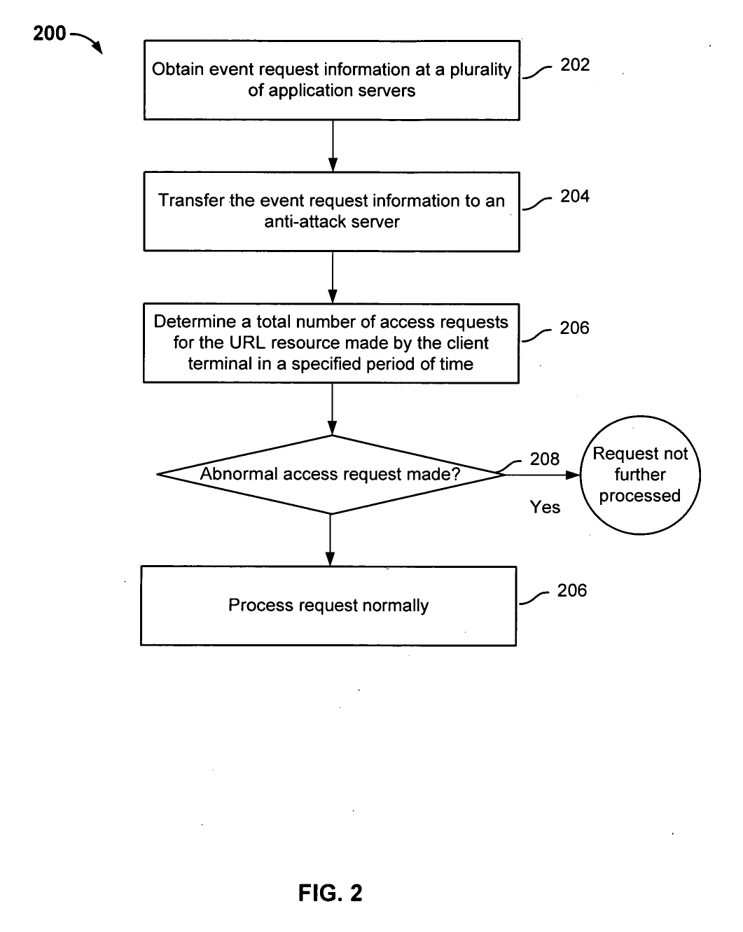

FIG. 2 is a flowchart illustrating an embodiment of a method for processing a request in a distributed application. Process 200 may be performed on a system such as 100. At 202, event request information is received at application servers. The event request information includes information pertaining to one or more resource access requests. Each resource access request is sent from a client terminal and corresponds to a URL resource. In some embodiments, the event request information includes: information of the time when the access request is received, the target URL, and identification information of the client terminal that made the access request. In some embodiments, the IP address of the client terminal acts as the identifier of the client terminal. In some embodiments, a client terminal's identification information may include COOKIE data of the client terminal and/or a Media Access Control (MAC) address of the client terminal.

In one example, at time t1, application server 112 receives an access request for a first URL (URL1) that is sent by a client terminal with an IP address 192.168.0.1; at time t2, application server 114 receives an access request for a second URL (URL2) that is sent by the same client terminal which has the IP address 192.168.0.1; at time t3, application server 116 receives an access request for URL1 that is sent by a client terminal with an IP address 192.168.0.2; and at time t4, application server 118 receives an access request for URL1 sent by the client terminal with IP address 192.168.0.1. A different number of requests may be received by the application servers.

The application servers extract relevant request information from the access requests. In the example discussed above, the application server 112 extracts a receiving time t1, URL1 and IP address 192.168.0.1 from the received access request. Application servers 114, 116, and 118 perform operations similar to those of the application server 112 and extract relevant event request information from their respective access requests.

At 204, event request information that pertains to a resource access request sent from a client terminal and is transferred to an anti-attack server, which accumulates statistics about the resource access requests. At 206, a total number of access requests for a URL resource that is made by a client during a specified time, including access requests received on different application servers, is determined. In the example discussed above, it is determined that the total number of access requests for URL1 from 109.168.0.1 in a time period that includes t1-t4 is 2, the total number of access requests for URL2 from 109.168.0.1 in this period is 1, and the total number of access requests for URL1 from 109.168.0.2 in this period is 1,

At 208, based on the total number of access requests and a predefined access rule, it is determined whether an abnormal access request has been made by the client terminal. In some embodiments, the predefined access rule sets a threshold count which, if exceeded, would indicate that the access is abnormal. In some embodiments, the frequency of access requests is computed by dividing the total number of access requests by the time period. The predefined access rule sets a frequency threshold which, if exceeded, would indicate that the access is abnormal. If the access is deemed abnormal, the application server that received and forwarded the event request information is notified. In some embodiments, the request is not further processed. In some embodiments, the notification includes a processing rule for special processing of the abnormal access request. If, however, the request is found to be normal, the application server is notified and the request is processed normally.

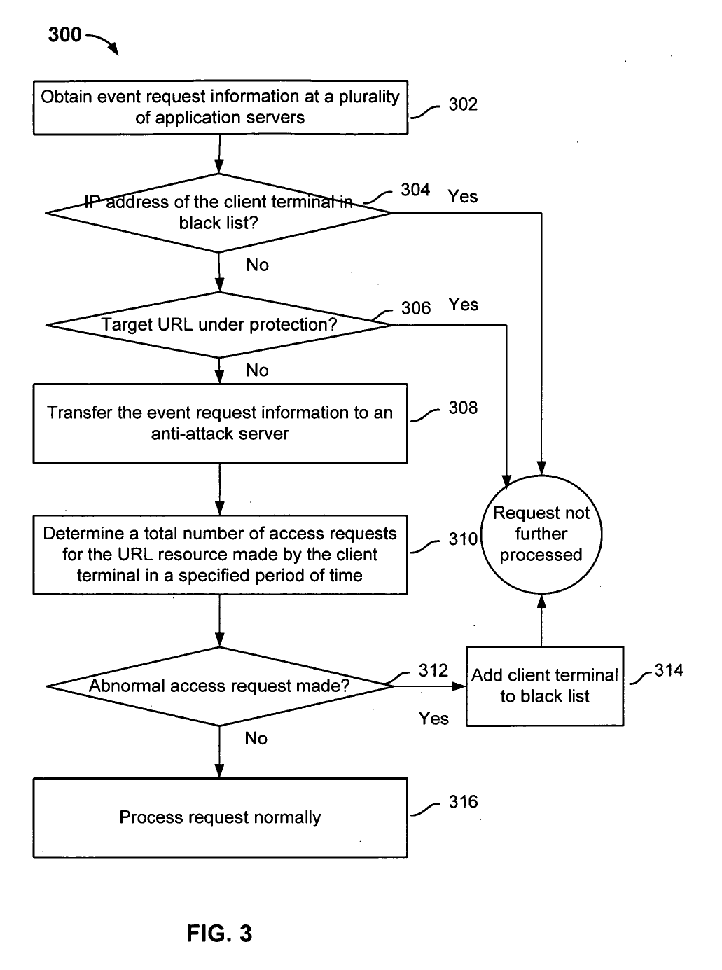

In some embodiments, if an access request is deemed to be abnormal, the identification for the client terminal that sent the access request (e.g., the IP address) is added to a blacklist. In some embodiments, a filter is used to identify any resource access request that is sent from a blacklisted client terminal. In some embodiments, the filter is also used to determine whether the target URL is under protection. The filter may be implemented as software, hardware, or a combination that runs on one or more of the application servers, on a separate device, or a combination. FIG. 3 is a flowchart illustrating an embodiment of a request processing process that utilizes a filter. At 302, event request information is obtained at a plurality of application servers. For each resource access request that is sent from a client terminal, at 304, it is determined whether the IP address of the client terminal from which the request originates is in the blacklist. If so, the application server rejects the access request immediately and the process ends; otherwise, the process proceeds to 306. For example, when a database filter reads the IP blacklist and finds that the IP address 192.168.0.2 is in the blacklist, the application server rejects the access request from the client terminal with the IP address 192.168.0.2. In addition, the filter finds that the IP address 192.168.0.1 is not in the blacklist, and the process proceeds to 306.

At 306, the filter extracts the target URLs, such as URL1 and URL2, from the event request information of the access requests received by the application servers, such as 112, 114, and 118. It is also determined whether the target URL associated with the resource access request is under protection. If the target URL is under protection, the access request is rejected and the process ends; otherwise, the process proceeds to 308. For example, if it is determined that that URL2 is under protection, that is, URL2 is not accessible, the access request on URL2 is rejected. The purpose of such processing is to implement multi-stage filtration, including both the filtration of the IP address and the filtration of the URL. If URL1 is not under protection, the process proceeds to 308.

At 308, the event request information, including the URL source information and the client terminal IP address, is transferred to an anti-attack server. At 310, the anti-attack server determines the total number of access requests for the URL resource made by the client terminal within a specified period of time, including the requests received by different application servers.

At 312, it is determined, based on the total number of access requests of the access requests for the URL resource from the client terminal and a predefined access rule, whether the access is abnormal. Depending on the practical situation of a service application, an access rule is set for a certain URL. For example, if the number of accesses to the URL exceeds a predetermined threshold in a certain period of time or the URL is accessible by some authorized users only but the requester is not authorized, the rule would indicate that the URL is not accessible at this point.

At 314, the client terminal corresponding to an abnormal access request is added to the blacklist. This may be implemented differently depending on the configuration of the system. In embodiments where each server tracks its own blacklist, the identification of the abnormal client terminal is sent to all the filters. In some embodiments where only a single blacklist is kept for the whole system, either on the filter or on the anti-attack server, the identification of the abnormal client terminal is sent to the device that tracks the blacklist.

For example, suppose that total number of the accesses to URL1 made by the client terminal with the identifier information of the IP address 192.168.0.1 in one minute is 100 and the predefined access rule corresponding to URL1 indicates that the number of accesses to URL1 made by a client terminal with the identifier information of the same IP address in one minute must not be more than 50, the anti-attack server determines that the access request on URL1 from the client terminal with the IP address 192.168.0.1 is abnormal. In some embodiments, the IP address 192.168.0.1 is locked for 5 minutes and the IP address 192.168.0.1 is returned to the application servers, which update the IP blacklist to add the IP address 192.168.0.1 into the IP blacklist. If a client terminal with the IP address 192.168.0.1 initiates an access request on URL1 within the 5 minutes period, the request would be rejected. The anti-attack server sends a predetermined processing rule to all the application servers. Each of the application servers may determine whether to reject all the accesses from the IP address 192.168.0.1 or reject the accesses to URL1 from the IP address 192.168.0.1 according to the predetermined processing rule.

At 316, the access request that passes the check of the filter and has no abnormality is processed normally. This step and identifying an abnormal request by the anti-attack server (steps 310-315) may be performed synchronously to ensure real-time service processing on the present access request. Additionally, it guarantees that the next access request from the IP address of the present access request can be processed according to the predetermined processing rule if the present access request is deemed to be a malicious attack.

It will be appreciated that one skilled in the art may make various modifications and alterations to the present invention without departing from the spirit and scope of the present invention. Accordingly, if these modifications and alterations to the present invention fall within the scope of the claims of the present invention and their equivalents, the present invention intends to include all these modifications and alterations.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for request processing in a distributed system, comprising:
obtaining event request information at a plurality of application servers, at least some of the event request information pertaining to a resource access request that is sent from a client terminal and that corresponds to a Uniform Resource Locator (URL) resource;
transferring the event request information to an anti-attack server;
determining, based at least in part on the at least some of the event request information, a total number of access requests to the URL resource made by the client terminal in a specified period of time; and
determining, based at least on the total number of access request determined and a predefined access rule, whether an abnormal access request has been made by the client terminal.

2. The method of claim 1, wherein the at least some of the event request information includes information of time when the access request is received, a target URL, and identification information of the client terminal.

3. The method of claim 1, wherein the at least some of the event request information is compared with a blacklist of known malicious client terminals stored on at least some of the application servers.

4. The method of claim 1, wherein a target URL included in the at least some of the event request information compared with a set of target URLs under protection.

5. The method of claim 1, in the event that it is determined that no abnormal access request has been made by the client terminal, the method further comprising processing the at least some of the event request information normally.

6. The method of claim 1, in the event that it is determined that an abnormal access request has been made by the client terminal, the method further comprising adding identification information of the client terminal to a blacklist.

7. The method of claim 1, wherein upon determining that an abnormal access request has been made by the client terminal, the method further comprises:
sending an a processing rule for the abnormal access request to the application server;
and processing, by the application servers, the abnormal access request according to the processing rule.

8. The method of claim 2, wherein, the identifier information of the client terminal comprises one or more selected from the group of: an Internet Protocol (IP) address, a Media Access Control (MAC) address, and COOKIE data.

9. A distributed application system comprising:
a plurality of application servers configured to:
obtain event request information, at least some of the event request information pertaining to a resource access request that is sent from a client terminal and that corresponds to a Uniform Resource Locator (URL) resource;
transfer the event request information to an anti-attack server; and an anti-attack server, configured to:
determine, based at least in part on the at least some of the event request information, a total number of access requests to the URL resource made by the client terminal in a specified period of time; and
determine, based at least on the total number of access request determined and a predefined access rule, whether an abnormal access request has been made by the client terminal.

10. The system of claim 9, wherein the at least some of the event request information includes information of time when the access request is received, a target URL, and identification information of the client terminal.

11. The system of claim 9, wherein the at least some of the event request information is compared with a blacklist of known malicious client terminals stored on at least some of the application servers.

12. The system of claim 9, wherein a target URL included in the at least some of the event request information compared with a set of target URLs under protection.

13. The system of claim 9, in the event that it is determined that no abnormal access request has been made by the client terminal, the plurality of application servers are further configured to process the at least some of the event request information normally.

14. The system of claim 9, in the event that it is determined that an abnormal access request has been made by the client terminal, the plurality of application servers are further configured to add identification information of the client terminal to a blacklist.

15. The system of claim 9, wherein upon determining that an abnormal access request has been made by the client terminal, the anti-attack servers is further configured to send an a processing rule for the abnormal access request to the application server; and
the application servers are further configured to process the abnormal access request according to the processing rule.

16. The system of claim 10, wherein, the identifier information of the client terminal comprises one or more selected from the group of: an Internet Protocol (IP) address, a Media Access Control (MAC) address, and COOKIE data.
